(19) United States
(12) Patent Application Publication
(10) Pub. No.: US 2006/0028958 A1
(43) Pub. Date: Feb. 9, 2006

(54) Alignment apparatus in an optical pickup device

(76) Inventors: Chin-Sung Liu, Hsinchu City (TW); Jinn-Kang Wang, Yonghe City (TW)

Correspondence Address: SUPREME PATENT SERVICES, P.O. BOX 2339, SARATOGA, CA, 95070-0339, US

(21) Appl. No.: 10/911,346

(22) Filed: Aug. 3, 2004

(51) Int. Cl. G11B 7/00

(52) U.S. Cl. 369/112.01; 369/44.11

(57) ABSTRACT

An alignment apparatus in an optical pickup device is provided. It comprises a laser diode, a first coupling carrier, an optical assembly, a signal detector, a record medium and a second coupling carrier. The first coupling carrier bears the laser diode while the second coupling carrier bears the optical assembly and the signal detector. The first coupling carrier has a coupling structure of a spherical curved surface. The second coupling carrier has a coupling structure of a curved surface or a plane tangential to the spherical curved surface of the first coupling carrier. The first and the second coupling carriers couple each other. The inclination angles with respect to two-axes and the polarization direction of the laser beam are adjusted by rotating the coupling structure of the spherical curved surface, which significantly reduces the time interval of calibration optimization of searching laser beam and also reaches the goal of optimization of light energy characteristics of the laser beam.

### FIELD OF THE INVENTION

The present invention relates to an optical alignment apparatus and, more particularly, to an alignment apparatus in an optical pickup device applied to optical record media.

### BACKGROUND OF THE INVENTION

In recent years, the storage density of recording medium has increased exponentially, and the market of optical discs is rapidly expanding. Developing the high-speed and high-accuracy alignment technology is the ultimate goal of the industry. In an optical pickup device to be used for reading data from or writing data onto an optical disk, the adjustment between a light source and a light receiving element is necessary for aligning the zero-cross point of focus detecting characteristics and the focal plane of the disk to be irradiated with an optical beam. There are three conventional methods to perform the adjustment, as follows:

1. A lens is moved in the directions of optical axes on the light receiving side;

2. The light receiving element is moved in the X, Y and Z directions; and

3. The light source is fixed on a holder and moved back and forth (as disclosed in Japanese Utility Model Kokai No. 40620/1991).

All the aforementioned methods use a large number of parts and a complicated structure to adjust so that the overall size is large. Furthermore, after the adjustment, the alignment between the zero-cross point for the focus detection and the focal plane of the disk to be illuminated with the optical beam is liable to be disturbed by the interference of other factors. If the lens or the light receiving element is moved on the light receiving side for the adjustment, the backlash caused by the movement may become a factor for prolonged time and the reduced accuracy for the adjustment of the light source.

In U.S. Pat. No. 5,517,362, Kasuga et. al. teaches an optical pickup device, which includes a frame as a base bearing a fixed optical element. The frame has a press-fit hole, in which the light source is pressed-fit and fixed at a pre-determined depth. By adjusting the depth of the light source inside the hole, the alignment between the optical pickup device and the disk can be achieved. This US patent features a simple mechanism for alignment, which is attained by adjusting the press-fit depth of the light source into the press-fit hole. However, the optical pickup device also has numerous parts and a complicated structure, and still needs size reduction. In addition, the press-fit depth of the light source into the press-fit hole is the result of the balance between the press-fitting force and the friction on both recesses of the press-fit hole and low elasticity material applied around the recesses. Therefore, it is doubtful that the high-accuracy required by optical devices is attainable and the time for making the adjustment is shortened. Additionally, the angular direction of divergence and the polarization direction of the light source are not adjustable by this method.

### SUMMARY OF THE INVENTION

An alignment apparatus in an optical pickup device is provided. It comprises a laser diode (LD), a first coupling carrier, an optical assembly, a signal detector, a record medium and a second coupling carrier. The first coupling carrier bears the laser diode that emits 1˜3 different wavelengths and has a coupling structure of a spherical curved surface. By rotating the spherical curved surface, the inclination angles with respect to two axes, i.e. x-axis and y-axis, and the polarization direction (the inclination angle with respect to z-axis) of the laser beam are adjusted. The second coupling carrier bears the optical assembly and the signal detector, and has a coupling structure of a curved surface or a plane tangential to the spherical curved surface of the first coupling carrier. The first and the second coupling carriers couple each other. Data is read from or written onto the record medium with the laser beam emitted by the laser diode. The signal detector receives the laser beam reflected by the record medium and detects an intensity of the laser beam. The optical assembly is positioned among the laser diode, the first coupling carrier and the signal detector and made up of optical lenses and mirrors. After adjusted and focused by the optical assembly, the laser beam is projected onto the record medium. The laser beam reflected by the record medium reenters the optical assembly and is guided to the signal detector.

The laser beam emitted by the LD is focused by the optical element to the optimal light projection spot on the record medium. The optimal optical alignment is achieved by the relative locations between the light spot of the LD and the collimating lens as well as the inclination angle of the folding mirror. Besides, the divergent inclination deviation and the polarization direction of the laser beam are adjusted by the concentric rotation of the first coupling carrier bearing the laser diode through the coupling structure of the first coupling carrier and the second coupling carrier. Since the light source is located at the center of the sphere of the spherical curved surface embraced by the coupling structure of the first coupling carrier and the second coupling carrier, the light source of the laser diode is not displaced with respect to the rotation of the first coupling carrier while the divergent inclination deviation and the polarization direction of the laser beam are adjusted by the concentric rotation of the first coupling carrier. Thus, the adjustment of the divergent inclinations and the polarization direction of the laser beam by using this alignment structure will not interfere with the displacement adjustment mechanism of the optimum projection of light spot on the record medium. The invention significantly reduces the time interval of calibration optimization of searching laser beam and also reaches the object of optimization of light energy characteristics of the laser beam.

### BRIEF DESCRIPTION OF THE DRAWINGS

FIG. 1 shows a schematic view of an alignment apparatus in an optical pickup device.

FIG. 2 shows a schematic view of the coupling structure of a first coupling carrier and a second coupling carrier.

FIG. 3 shows a schematic view of the first coupling carrier.

### DETAILED DESCRIPTION OF THE PREFERRED EMBODIMENTS

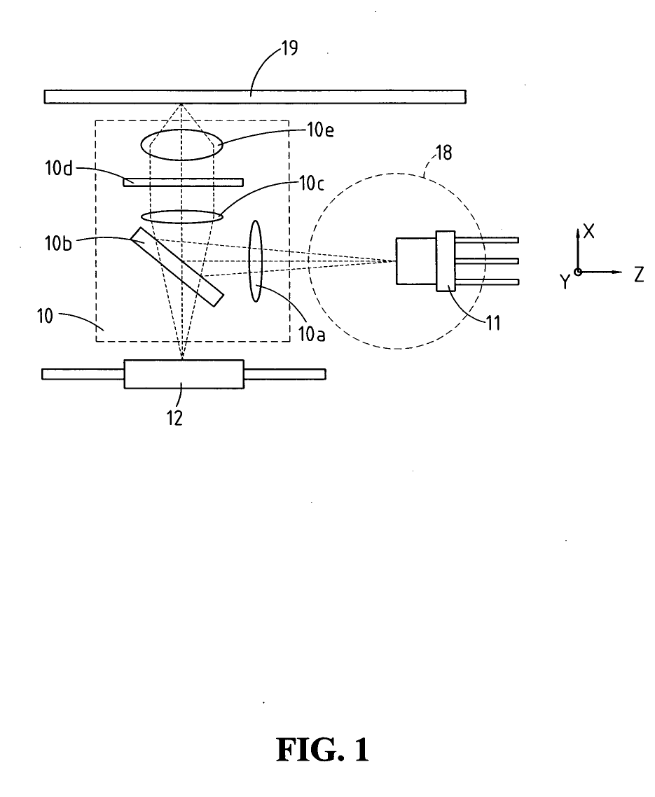

FIG. 1 shows a schematic view of an alignment apparatus in an optical pickup device. A laser diode 11 is embraced by a spherical curved surface 18. A light source of the diode is located at the center of the sphere of the spherical curved surface 18. An optical assembly 10 comprises a coupling lens 10a, a beam splitter 10b, a collimating lens 10c, a folding mirror 10d and an objective lens 10e. Before projected onto a record medium 19, a laser beam emitted by the laser diode 11 with 1˜3 different wavelengths sequentially passes through the coupling lens 10a, the beam splitter 10b, the collimating lens 10c, the folding mirror 10d and the objective lens 10e. After the laser beam has been fed-back to the objective lens 10e, the folding mirror 10d, the collimating lens 10c and the beam splitter 10b by the surface reflection on the record medium 19, the laser beam is received and detected by a signal detector 12. Data is read from or written onto the record medium 19 with the laser beam emitted by the laser diode 11. The signal detector 12 receives the laser beam reflected from the record medium 19, and detects an intensity of the laser beam. The coupling lens 10a adjusts the collimation of the laser beam through the collimating lens 10c and increases the light coupling efficiency. The beam splitter 10b allows a part of the laser beam to go through, but reflects the rest of the light. Therefore, it has both reflection and transmission functions. The collimating lens 10c collimates the divergent laser beam to a parallel laser beam. The function of the folding mirror 10d is to totally reflect the laser beam. In this embodiment, the angle of the incident laser beam on the folding mirror 10d is 45 degree. The incident laser beam and the reflected laser beam from the folding mirror 10d form an angle of 90 degree. The objective lens 10e has a fixed focal length and focuses the laser beam into a spot.

The light source of the laser beam is located at the center of the sphere of a spherical curved surface 18; moreover, the laser diode 11 synchronously rotates with the spherical curved surface 18. Therefore, the inclination angles with respect to x-axis and y-axis respectively and the polarization direction (i.e. the inclination angle with respect to z-axis) of the laser beam are adjusted by rotating the spherical curved surface 18. The displacements with respect to x-axis and y-axis of the projection point on the record medium are corrected by adjusting the inclination angles with respect to two axes of the folding mirror 10d while the displacement with respect to z-axis is corrected by moving the coupling lens 10a back and forth. The mechanism that utilizes the concentric alignment rotation to adjust the divergent inclinations and the polarization direction of the laser beam does not result in the displacement of the light source. Therefore, it does not cause any displacement of the projection location of the laser beam on the record medium 19. During the calibrations of both optical accuracy and optimization of light energy characteristics, the mechanism of adjusting the divergent inclinations and the polarization direction of the laser beam is independent of but synchronous with the mechanism of adjusting the displacement of the laser beam. They do not interfere with each other, thus significantly reducing the calibration time and also reaching the goal of projection and focus optimization of light energy.

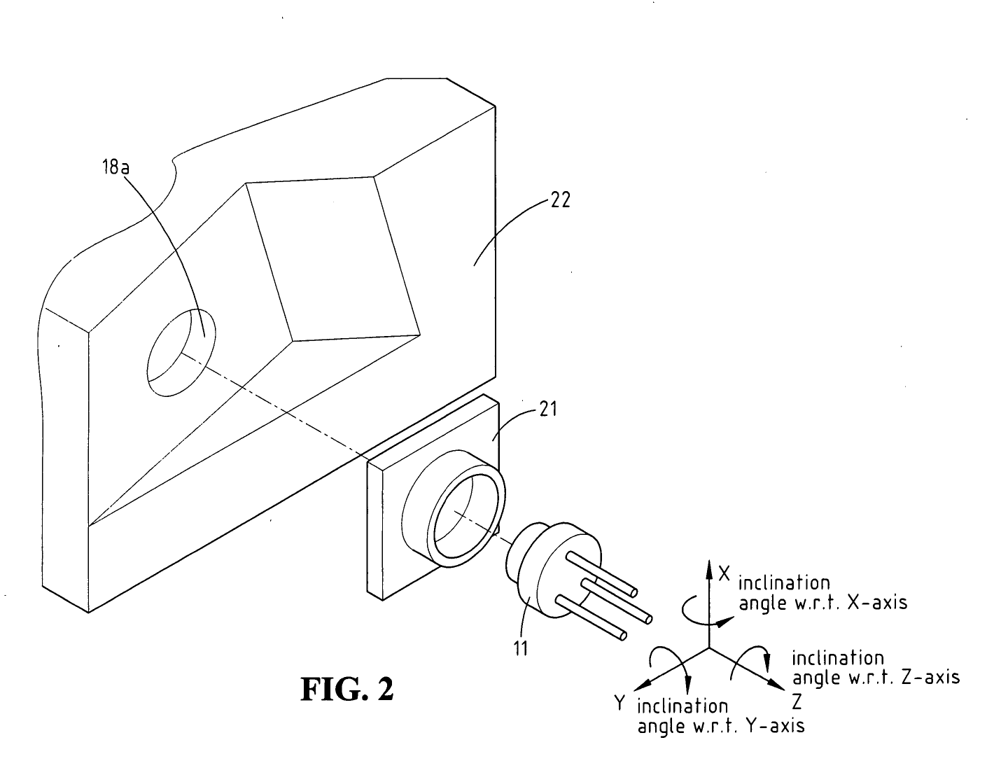

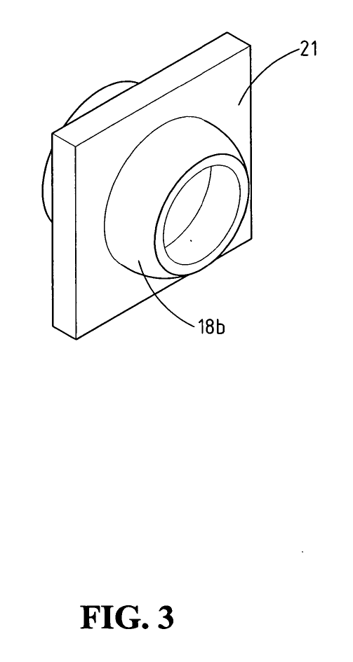

FIG. 2 shows a schematic view of the coupling structure of a first coupling carrier 21 and a second coupling carrier 22. The first coupling carrier 21 has a coupling structure of a spherical curved surface for bearing the laser diode 11. The second coupling carrier 22 has a coupling structure of a curved surface or a plane tangential to the spherical curved surface of the first coupling carrier 21 and bears the optical assembly 10 and the signal detector 12. FIG. 3 shows a schematic view of the first coupling carrier 21. After coupling the first coupling carrier 21 and the second coupling carrier 22, the spherical curved surface 18b and the curved surface or the plane 18a are connected. The light source of the laser diode 11 is located at the center of the sphere. By way of rotating the first coupling carrier 21 but not moving the location of the light source of the laser diode 11, the inclination angles with respect to two axes and the polarization direction of the laser beam are adjustable. Hence, the goal of optimization of light energy characteristics is reached.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An alignment apparatus in an optical pickup device comprising:
a laser diode being a laser light source and emitting a laser beam;
a first coupling carrier having a coupling structure of a spherical curved surface and bearing said laser diode;
a record medium being read or written with said laser beam;
a signal detector receiving and detecting an intensity of said laser beam reflected by said record medium;
an optical assembly being positioned among said laser diode, said first coupling carrier and said signal detector, receiving said laser beam emitted by said laser diode, focusing and projecting said laser beam onto said record medium, receiving said laser beam reflected by said record medium and guiding said laser beam to said signal detector; and
a second coupling carrier having a coupling structure of a curved surface or a plane tangential to said spherical curved surface of said first coupling carrier, coupling said first coupling carrier, and bearing said optical assembly and said signal detector.

2. The alignment apparatus in an optical pickup device as claimed in claim 1, wherein said optical assembly further comprises:
a coupling lens adjusting the collimation of said laser beam and increasing the light coupling efficiency;
a beam splitter changing the direction of propagation of said laser beam and having reflection and transmission functions;
a collimating lens collimating said divergent laser beam to a parallel beam;
a folding mirror adjusting the direction of propagation; and
an objective lens focusing said laser beam.

3. The alignment apparatus in an optical pickup device as claimed in claim 1, wherein said laser diode is a laser light source that emits 1˜3 different wavelengths.

4. The alignment apparatus in an optical pickup device as claimed in claim 1, wherein said first and said second coupling carriers couple each other, and the center of the sphere of said spherical curved surface is not changed with respect to the rotation of said first coupling carrier.

5. The alignment apparatus in an optical pickup device as claimed in claim 1, wherein said light source of said laser diode is located at the center of the sphere of the spherical curved surface of said first coupling carrier.

6. The alignment apparatus in an optical pickup device as claimed in claim 1, wherein the coupling structure of said first and said second coupling carriers adjusts the inclination angles with respect to x-axis and y-axis respectively, and changes the laser light source of said laser diode.

7. The alignment apparatus in an optical pickup device as claimed in claim 1, wherein the coupling structure of said first and said second coupling carriers adjusts the rotation in the polarization direction of said laser beam of said laser diode.

8. The alignment apparatus in an optical pickup device as claimed in claim 1, wherein said optical assembly adjusts the deviations with respect to x-axis, y-axis and z-axis, and changes the location of a projection spot of said laser beam focused on said record medium.

9. The alignment apparatus in an optical pickup device as claimed in claim 2, wherein the back and forth displacement of said coupling lens adjusts the deviation with respect to the z-axis, and changes the location of a projection spot of said laser beam focused on said record medium.

10. The alignment apparatus in an optical pickup device as claimed in claim 2, wherein the inclination angle of said folding mirror adjusts the deviations with respect to x-axis and y-axis, and changes the location of a projection spot of said laser beam focused on said record medium.
